(19) United States
(12) Patent Application Publication
(10) Pub. No.: US 2019/0370279 A1
(43) Pub. Date: Dec. 5, 2019

(54) SYSTEMS AND METHODS FOR INITIALIZATION OF RECOMMENDATION SYSTEM BASED ON REMOTE PROFILES

(71) Applicant: SYSTEMS AND SOFTWARE ENTERPRISES, LLC, Brea, CA (US)

(72) Inventors: Nicolas Aussel, München (DE); Eriza Fazli, Gilching (DE); Matteo Berioli, München (DE)

(21) Appl. No.: 16/428,614

(22) Filed: May 31, 2019

Related U.S. Application Data
(60) Provisional application No. 62/679,546, filed on Jun. 1, 2018.

(51) Int. Cl. G06F 16/435; G06F 16/9535; G06F 16/9538

(52) U.S. Cl. CPC G06F 16/437; G06F 16/9538; G06F 16/9535

(57) ABSTRACT

Systems and methods are described herein for providing user-specific recommendations to one or more users. A recommendation server having memory and a processor communicatively coupled therewith can be used to generate and present a recommendation to a user based at least in part on the demographic information received from the user's device. After generating the recommendation, the server can delete the received demographic information, such that it is only stored on the user's device.

This application claims priority to U.S. provisional application Ser. No. 62/679,546 filed on Jun. 1, 2018. This and all other referenced extrinsic materials are incorporated herein by reference in their entirety. Where a definition or use of a term in a reference that is incorporated by reference is inconsistent or contrary to the definition of that term provided herein, the definition of that term provided herein is deemed to be controlling.

### FIELD OF THE INVENTION

The field of the invention is recommendation systems and methods.

### BACKGROUND

The following description includes information that may be useful in understanding the present invention. It is not an admission that any of the information provided herein is prior art or relevant to the presently claimed invention, or that any publication specifically or implicitly referenced is prior art.

Online stores and user-generated media platforms utilize recommendation systems to facilitate browsing of a high number of items. Such systems generally rely on centrally-stored data about a user's preferences and either intrinsic properties of the items (i.e., content-based recommenders) or other users' preferences (i.e., collaborative filtering recommenders).

Recommender performance can be further increased by the addition of demographic information related to the users and context information related to the usage of the recommender system. However, demographic information about users is sensitive information. This limits the way it can be collected and stored, and users' willingness to provide such information for storage outside of the users' control.

The most common approach is requiring users to create a personal account and provide this information as part of the account creation process. This information is then typically stored on a server associated with the company.

For recommendation systems for vehicular content distribution networks, systems that require account creation to enable recommendations can be a significant inconvenience and inhibit their use as the use of the account is limited in time, especially on short trips in an aircraft or other vehicle.

All publications identified herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

Thus, there is still a need for systems and methods for recommending content that eliminate the need for a user to create a user account and provide personal information stored in the system.

### SUMMARY OF THE INVENTION

The inventive subject matter provides apparatus, systems and methods for generating user-specific (e.g., individualized) content recommendations for each user. Preferably, such systems and methods are utilized in conjunction with an in-vehicle network.

Contemplated systems and methods utilize a recommendation server communicatively coupled with a processor, where the server or processor is configured to receive demographic information about a user from the user's device. Using this information, the processor can generate and present a recommendation based at least in part on the demographic information received. After the recommendation is transmitted to the user's device, the user's demographic information is preferably deleted from the server, such that the user's demographic information is not centrally stored and instead resides on the user's device.

Prior to deletion, it is contemplated that the system could create a user profile based at least in part on the received demographic information of the user. This user profile can then be used to generate one or more content recommendations for the user in place of or in conjunction with the user's demographic information. The user profile can be transmitted to the user's device for storage. After transmitting the user profile to the user's device, the user profile is preferably deleted from the server.

It is also contemplated that the processor could update the user profile based on a user's interaction with the system, and to cause the updated user profile to be transmitted to and stored on the user device. Again, the updated user profile is preferably deleted from the server after the profile is transmitted to the user's device. Such user's interaction can include, for example, (i) a user selecting content, (ii) the user reviewing content, (iii) the user liking content, (iv) the user adding content to a playlist, and (v) the user skipping content.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWINGS

FIG. 1 is a diagram of one embodiment of a recommendation system.

### DETAILED DESCRIPTION

Throughout the following discussion, numerous references will be made regarding servers, services, interfaces, portals, platforms, or other systems formed from computing devices. It should be appreciated that the use of such terms is deemed to represent one or more computing devices having at least one processor configured to execute software instructions stored on a computer readable tangible, non-transitory medium. For example, a server can include one or more computers operating as a web server, database server, or other type of computer server in a manner to fulfill described roles, responsibilities, or functions.

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

Although the discussion herein focuses on an aircraft, it is contemplated that the systems and methods discussed herein could similarly be used on ships, trains, busses, and other vehicles.

The inventive subject matter describes systems and methods for providing content recommendations to a plurality of users without requiring centralized storage of each user's personal information.

Contemplated systems and methods advantageously combine the following features: (i) elimination of the need for storage of personal data in the vehicular content distribution network; and (ii) initialization of user profiles using only demographic elements contemporaneously received from the user (e.g., when the user connects a mobile device to the vehicular content distribution network). In this manner, such systems and methods have the technical effect of not requiring central storage of user information while effectively providing individualized recommendations to users based on their demographics and interaction with the system.

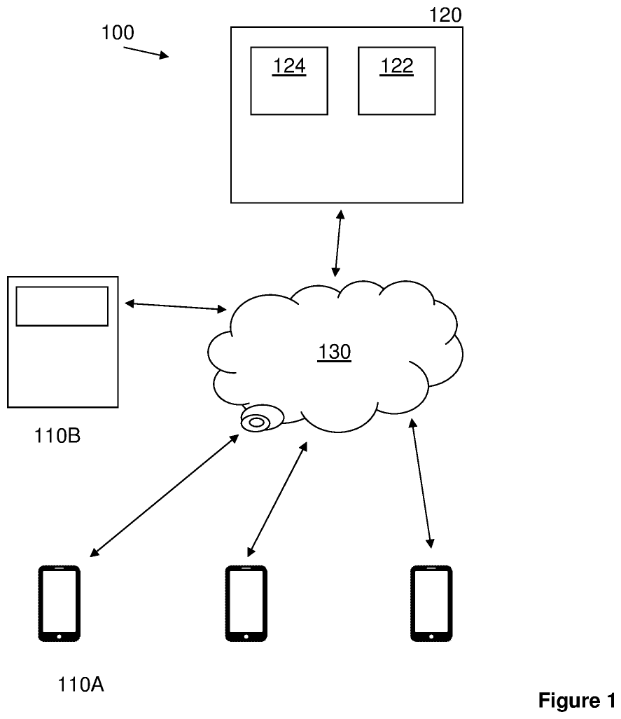

In one embodiment shown in FIG. 1, system 100 is configured to provide user-specific content recommendations to one or more users, preferably all of which are connected to an in-vehicle network. System 100 comprises a recommendation server 120 having a processor 122 and memory 124 communicatively coupled with the recommendation server 120. The server 120 is preferably configured to receive demographic information from a user's mobile or other portable computing device 110A, as well as other users' devices and potentially in-flight entertainment devices disposed within a vehicle. Preferably, such information is transmitted over an in-vehicle wireless network 130, although a wired network could also be used.

The server 120 invites/requests one or more users to install a software program on the user device 110A. In some embodiments, this can occur outside of the vehicle on a separate network, such as prior to a user boarding the vehicle. Contemplated user devices include, for example, smart phones, tablet PCs, smart watches, e-readers, and so forth. Where the user is utilizing an in-vehicle entertainment device 110B, such as those typically having a display screen disposed in a seat back on an aircraft or other vehicle, it is contemplated that the software program can be preinstalled on the device 110B and information/recommendations can be presented on the display screen.

After the software program is installed on the user's device 110A, the user is requested by server 120 to create an account. During the account creation or afterwards, the system 100 can request demographic elements explicitly or obtain them such as by automatic mining of the user's device 110A.

When the user connects the user's device 110A to a vehicular content distribution network 130, the software program automatically transmits relevant information from the user's account on the user's device 110A to the recommendation server 120. Such information can include, for example, user demographic information and/or a user profile stored on the user device 110A.

The processor 122 is preferably configured to generate and present one or more recommendations to the user on the user device 110A based at least in part on the demographic information and/or user profile received. After generating the one or more recommendations, the processor 122 can cause the received demographic information/user profile to be deleted from server 120. In this manner, such systems and methods advantageously ensure that personal data from a user is not stored on the server 120 or within system 100 but instead is stored locally on the user's device 110A.

Thus, it is contemplated that if a user deletes the application from the user's device 110A (and with it the personal data stored on the user's device 110A), all personal data of the user in the vehicular network(s) will also be deleted, as the information is not centrally stored on server 120.

In addition, there is no need to track users when they are moving from one vehicular network to another or across several vehicular networks, because every time a user's profile is reinitialized.

In some embodiments, the processor 122 can be configured to create a user profile based at least in part on the demographic information received from user device 110A. The user profile can then be transmitted over the in-vehicle network to the user device 110A, and then deleted from the server 120.

In such embodiments, it is contemplated that the processor 122 can be configured to receive the user profile from the user device 110A, and generate and present the recommendation based at least in part on the user profile received. It is also contemplated that the processor 122 could update the user profile based on a user's interaction with the system 100, and cause the updated user profile to be transmitted to and stored on the user device 110A. Such user's interactions could include, for example, (i) the user selecting content, (ii) the user reviewing content, (iii) the user liking content, (iv) the user adding content to a playlist, and (v) the user skipping content. It may also include an amount of time a user spends on a piece of content and/or whether the user requests more information about a piece of content.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

In some embodiments, the numbers expressing quantities of ingredients, properties such as concentration, reaction conditions, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

Unless the context dictates the contrary, all ranges set forth herein should be interpreted as being inclusive of their endpoints and open-ended ranges should be interpreted to include only commercially practical values. Similarly, all lists of values should be considered as inclusive of intermediate values unless the context indicates the contrary.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The recitation of ranges of values herein is merely intended to serve as a shorthand method of referring individually to each separate value falling within the range. Unless otherwise indicated herein, each individual value with a range is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A system for providing user-specific recommendations, comprising:
a recommendation server having a processor and memory communicatively coupled with one another;
the recommendation server configured to receive demographic information from a user device;
wherein the processor is configured to generate a content recommendation based at least in part on the demographic information received, and transmit the content recommendation to the user device; and
wherein the processor deletes the received demographic information after generating the content recommendation.

2. The system of claim 1, wherein the demographic information is stored only on the user device.

3. The system of claim 1, further comprising a display screen disposed in a seat back, and wherein the processor causes the recommendation to be presented on the display screen.

4. The system of claim 1, wherein the processor causes the recommendation to be presented on the user device.

5. The system of claim 1, further comprising:
the processor creating a user profile based at least in part on the demographic information received from the user device; and
the processor causing the user profile to be transmitted to the user device.

6. The system of claim 5, wherein the processor is further configured to delete the user profile from the server after transmitting the user profile to the user device.

7. The system of claim 5, wherein the processor is further configured to receive the user profile from the user device, and generate and present the recommendation based at least in part on the user profile received.

8. The system of claim 7, wherein the processor deletes the user profile after generating the recommendation.

9. The system of claim 7, wherein the processor is further configured to update the user profile based on a user's interaction with the system, and to cause the updated user profile to be transmitted to and stored on the user device.

10. The system of claim 9, wherein the user's interaction comprises one or more of (i) a user selecting content, (ii) the user reviewing content, (iii) the user liking content, (iv) the user adding content to a playlist, and (v) the user skipping content.

11. A method for providing user-specific recommendations in an in-vehicle network, comprising:
providing a recommendation server having a processor and a memory, the processor communicatively coupled with the recommendation server;
receiving demographic information from a user device having a storage where the demographic information is stored, wherein the user device is connected to the in-vehicle network;
temporarily storing the received demographic information in the memory;
analyzing and generating one or more recommendations using the processor based at least in part on the demographic information received from the user device;
the processor causing the one or more recommendations to be presented on the user device; and
the processor deleting the received demographic information from the memory after presenting the recommendation.

12. The method of claim 11, further comprising:
creating a user profile using the processor and based at least in part on the demographic information, wherein the user profile is temporarily stored in the memory;
transmitting the user profile to the user device; and
the processor sending a command to cause the user profile to be deleted from the memory after transmitting the user profile to the user device.

13. The method of claim 12, further comprising:
receiving the user profile from the user device;
analyzing and generating the one or more recommendations using the processor based at least in part on the user profile received from the user device; and
the processor causing the one or more recommendations to be presented on the user device.

14. The method of claim 12, further comprising:
updating the user profile using the processor and based on a user's interaction with the system; and
transmitting the updated user profile to the user device.

15. The method of claim 14, wherein the user's interaction comprises one or more of (i) a user selecting content, (ii) the user reviewing content, (iii) the user liking content, (iv) the user adding content to a playlist, and (v) the user skipping content.
